(19) United States
(12) Patent Application Publication
(10) Pub. No.: US 2011/0194856 A1
(43) Pub. Date: Aug. 11, 2011

(54) CONTROL FOR A DEVICE

(75) Inventors: Nirmal Sabarwal, London (GB); Peter Benmax, London (GB)

(73) Assignee: GREENER POWER LIMITED, London (GB)

(21) Appl. No.: 13/088,845

(22) Filed: Apr. 18, 2011

(30) Foreign Application Priority Data
Oct. 17, 2008 (GB) GB0819120.7
Oct. 16, 2009 (GB) PCT/GB2009/002496

(51) Int. Cl. H05B 41/36; H04B 10/00; H04L 17/02

(52) U.S. Cl. 398/106; 315/158; 341/176

(57) ABSTRACT

A control for an electrical device, where in the control can include a receiver for receiving modulated electromagnetic radiation. The received radiation can be integrated by an analyzer, and an aspect of the electrical device can be controlled when radiation is detected. The integration period used by the analyzer can be greater than the period of a pulse in the modulated electromagnetic radiation such that the aspect of the device can be controlled independently of modulation in the received electromagnetic radiation.

### CROSS REFERENCE TO RELATED APPLICATIONS

The present application claims priority to and the benefit of co-pending International Application Number PCT/GB2009/002496 filed on Oct. 16, 2009, entitled “A CONTROL FOR A DEVICE,” which claims priority to GB Application No. 0819120.7 filed on Oct. 17, 2008. These references are incorporated in their entirety herein.

### FIELD

The present embodiments generally relate to the control of devices, and in particular the remote control of electric lights.

### BACKGROUND

A need exists for an apparatus and method for controlling devices, such as remote control of electric lights.

Electrical devices are often controlled using a tool that is directly connected to the device. Typical tools for controlling devices include buttons, a mouse, a touch screen, switches, dials, and the like. A disadvantage of direct control of this type is that a user may need to be collocated with a device, or else cables are required.

Electrical devices can also be controlled using remote-controls. A remote-control can include any of the tools or controlling devices mentioned above in wireless communication with the device. A disadvantage of remote control is that a dedicated transmitter can be required to supply the device with a signal that it can interpret. As a consequence, a user can accumulate a large number of remote controls, each dedicated to a particular device. Another disadvantage is that a remote-control can add to the cost of a device because two components must be designed: the device itself, and the remote-control.

Providing remote-controls for many devices can add cost and complexity to the device.

A need exists for a device and method that enables for the remote control of an aspect of a device without the need for a dedicated transmitter.

The present embodiments meet these needs.

### BRIEF DESCRIPTION OF THE DRAWINGS

The detailed description will be better understood in conjunction with the accompanying drawings as follows:

FIG. 1 is a schematic diagram showing a remote-control and a control for an electric light according to one or more embodiments.

FIG. 2 shows detail of an analyzer in a control according to one or more embodiments.

FIG. 3 shows an electric light bulb integrated with a control according to one or more embodiments.

FIG. 4 is an exploded view of a light bulb, an adaptor, and a light socket, where the adaptor comprises a control according to one or more embodiments.

FIG. 5 is a schematic diagram of a string of electric lights including controls according to one or more embodiments.

FIG. 6 shows a circuit diagram for use in one or more embodiments.

FIG. 7 shows another circuit diagram for use in according to one or more embodiments.

FIG. 8 shows an electronic starter integrated with a control according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to the control of devices, and in particular to the remote control of electric lights. The device can be an electrical device.

The control for the device can include: a receiver for receiving modulated electromagnetic radiation, a means for integrating the received electromagnetic radiation over an integration period, and means for controlling an aspect of the device when the electromagnetic radiation is detected.

The integration period can be greater than the period of a pulse in the modulated electromagnetic radiation so that the aspect of the device can be controlled independently of modulation in the received electromagnetic radiation.

As such, any remote-control that transmits modulated electromagnetic signals can be used to control an aspect of the device. The signal can be integrated over a period that is longer than the period of a modulated pulse. Therefore, the control can respond in the same way to two strings of pulses with different modulation characteristics, which can be achieved because the control can smear out the received signal, and look for a string of pulses that can be associated with the depression of a button on a remote-control.

In one or more embodiments, the control may not be able to resolve an individual pulse in the received signal if the period of integration is longer than the period of a modulated pulse. Therefore, rapid activation of the control by each pulse in a train of pulses can be avoided.

By integrating the received radiation, accidental activation of the control can be eliminated. In particular, any isolated spikes in the signal can have a small effect on an integrated signal when the integration period is long in relation to the duration of the spike.

For example, one or more embodiments of the control can be used to switch an electric light on and off. The control can operate when a signal is received from a conventional remote-control, such as a remote-control for a television. The operation of the control can be independent of the actual nature of the modulations, and any intended meaning of the modulations, because the integration period is greater than the period of modulations and so individual modulations are not resolved. As such, the depression of any button on a conventional remote-control can be used equally to control an aspect of a device.

In a conventional remote-control system, a remote-control is provided with a plurality of buttons for controlling a plurality of aspects of a target device, such as a television. The remote-control can transmit modulated infra-red (IR) radiation, where the characteristics of the modulation are dependent on the button that is pressed. The target device can receive the transmitted IR light, detect modulations therein, and interpret the meaning of the modulations by comparing them with a code that is stored locally. As such, a television can change a channel or increase the output volume, as appropriate according to the meaning of the modulations. One or more embodiments of the present device does not include a means for interpreting the meaning of any detected modulation.

In one or more embodiments, the device can be an electric appliance. The control can be arranged to control any aspect of the electric appliance. In one or more embodiments, the device can be an electric light, and the control can be arranged to switch the light on or off. However, the control can be used for any conceivable device, such as a device where a remote control is desirable but the production of a dedicated remote-control is undesirable.

The device can be an electronic starter for a low power fluorescent light. By integrating the control with the electronic starter, normal operation of a low power light can be interrupted such that a start-up sequence can only be initiated when the receiver receives modulated radiation.

In one or more embodiments, the power consumption of the control means for the device can be less than 100 mW. The power consumption can be less than 20 mW, and can range from 0.5 mW to 20 mW. As such, the control means can operate with very low power demands.

The device can be controlled between two states. As such, the control can be a switch for a binary control of one aspect of the device. For example, the control can switch the device on or off each time radiation is detected. In one or more embodiments, the control can be arranged to control the device between two states only.

In one or more embodiments, the control can control the device between more than two states. For example, the control can cycle through a range of alternatives. Thus, the color of light emitted by the device can change between four alternatives each time radiation is detected.

The sensitivity of the receiver to electromagnetic radiation can be controlled. It may be desirable to avoid unintended activation of the control. Such unintended activation can occur when radiation is transmitted with the intention of controlling a particular device, but the radiation is detected inadvertently by the control. By controlling the sensitivity of the receiver, the likelihood of unintended activation can be reduced.

The sensitivity of the receiver can be reduced to the extent that transmissions from a normal remote-control would only be detected if they are received above a predetermined threshold power. As such, the modulated radiation transmitted by a remote-control can activate the control only if the remote-control is within a certain range of the device. For example, in one arrangement, a standard remote-control can only activate the control if it is within about 5 m of the receiver.

The sensitivity of the receiver can be controlled by filtering out any received electromagnetic radiation that is below a certain power. Alternatively, a shroud can be provided around the receiver.

The receiver can be shrouded with any suitable material, such as a metal foil. Alternatively, the receiver can be shrouded by the housing of the control. As such, the receiver can only detect electromagnetic radiation above a certain power.

In one or more embodiments, the receiver can be highly sensitive to electromagnetic radiation, such as in circumstances where unintended activation of the control is unlikely. For example, the control can be for controlling the operation of ceiling lights in a high conference hall, and the receiver can be co-located with the ceiling lights.

The sensitivity of the receiver to electromagnetic radiation can be controlled in at least one direction. As such, the directionality of the receiver can be controlled.

Typically remote-controls can transmit electromagnetic radiation in a wide solid angle, which allows activation of a target device even if the remote-control is not pointed accurately at the device. While this can be desirable in some circumstances, it can increase the likelihood of accidental activation of the device by radiation intended for other targets. By controlling the sensitivity of the receiver in particular directions the control can be configured such that direct pointing along these particular directions is required for activation.

The control can include a structure in which the receiver is recessed, enabling the directionality of the receiver to be controlled. As such, only radiation that is received through the solid angle defined by the recess can be received by the receiver.

The receiver can be sensitive to infra-red radiation. By receiving modulated infra-red radiation the receiver can be sensitive to the radiation that is transmitted by many conventional remote-controls. The receiver can be sensitive to wavelengths in the range of 750 nm to around 1 mm. In one or more embodiments, the receiver can be sensitive to wavelengths in the range of 850 nm to 1050 nm. One or more embodiments can include a receiver that is sensitive to wavelengths in the region of 950 nm.

In one or more embodiments, the receiver can be sensitive to radio frequency radiation, visible light, or ultraviolet radiation, for example.

The integration period can be in the region of 1 ms. Thus, the device can be controlled independently of any modulation that occurs at a rate greater than around 1 kHz. In operation, if a user presses a button on a remote-control a few times per second, each button depression can be detected by the control because the integration period can be shorter than the button depression rate.

The control can include means for detecting modulation in the received radiation. The device can be controlled when modulation is detected. By examining the received signal for the presence of modulations, the control can eliminate unintended activation by unmodulated electromagnetic signals, such as sunlight.

The means for detecting modulation can be arranged to detect amplitude modulation. The amplitude modulation can involve on-off keying, such that the signal is modulated by the presence and absence of a carrier. Modulation of this kind is prevalent in traditional IR remote-controls that employ pulses with a temporal width of around 1 μs. On-off keying can be a desirable form of modulation because detection of the modulation is possible even in the presence of significant levels of interference.

In one or more embodiments the means for detecting modulation can be arranged to detect frequency modulation or phase modulation.

In order to resolve modulations that occur with a micro-second period, the signal can be integrated using an integration period that is shorter than the period of the shortest expected pulse. The control can analyze the signal using two integration periods, including a first integration period that can be greater than the period of a pulse in the modulated signal and a second integration period in the order of a micro-second for resolving individual modulations.

One or more embodiments relate to a device including a control as described herein, wherein the control is integrated with the device. As such, the control can be included as part of the device. For example, the device can be a standard light bulb and the control can be integrated with the light bulb. The control can be invisible to a user apart from an infra-red receiver that can be visible in a window in a housing of the device.

One or more embodiments relate to a fitting for an electrical device including a control as described herein. The control can be arranged to control an aspect of the electrical device when radiation is detected. For example, the fitting can be an adapter positioned between a standard wall socket and an electrical appliance. The adapter can be arranged to plug into a standard wall plug and to receive a plug that is connected to the electrical device. When the receiver receives electromagnetic radiation, the control in the fitting can control an aspect of the electrical device. The fitting can be a light fitting.

One or more embodiments relate to an adapter for connection between a light fitting and a light source comprising a control as described herein. The control can be arranged to control an aspect of the light source when radiation is detected. The adapter can be connected between a traditional light fitting and a light bulb. As such, a standard light socket can be adapted so that an aspect of the light bulb can be controlled.

The adapter can include pin connectors and can be a bayonet-to-bayonet connector, a screw-thread-to-screw-thread connector, a bayonet-to-screw-thread connector, or a screw-thread-to-bayonet connector, for example.

One or more embodiments relate to a remote control system including a control as described herein and a transmitter for transmitting modulated electromagnetic radiation. The radiation from the transmitter can be modulated differently in response to different user actions, and the control can be arranged to operate in the same way independently of the modulations in the received radiation. As such, a transmitter can be designed to control a third party device in a plurality of different ways by transmitting coded modulations in the radiation. The control can receive the modulated radiation and operate in the same way, independently of the code therein.

One or more embodiments relate to a method of controlling a device. The method can include: receiving modulated electromagnetic radiation, integrating the received electromagnetic radiation over an integration period, and controlling an aspect of the device when the modulated electromagnetic radiation is detected. The integration period can be greater than the period of a pulse in the modulated electromagnetic radiation, such that the aspect of the device can be controlled independently of modulation in the received electromagnetic radiation.

One or more embodiments relate to a light switch including: a receiver for receiving modulated infra-red radiation from a remote-control, means for integrating the received infra-red radiation over an integration period, and means for switching the light on or off when radiation is detected. The integration period can be greater than the period of a pulse in the modulated radiation such that the light can be controlled independently of modulation in the received radiation. As such, a light switch can be controlled by any conventional remote-control that emits infra-red radiation. In one or more embodiments, the light switch can be positioned in any convenient location.

For example, the light switch can be located on a wall, such as when the light is in a ceiling. Also, the light switch can be integrated with the light.

Any of the features of the apparatus disclosed herein can be provided as features of the method disclosed herein. Any of the features of the method disclosed herein can be provided as features of the apparatus disclosed herein.

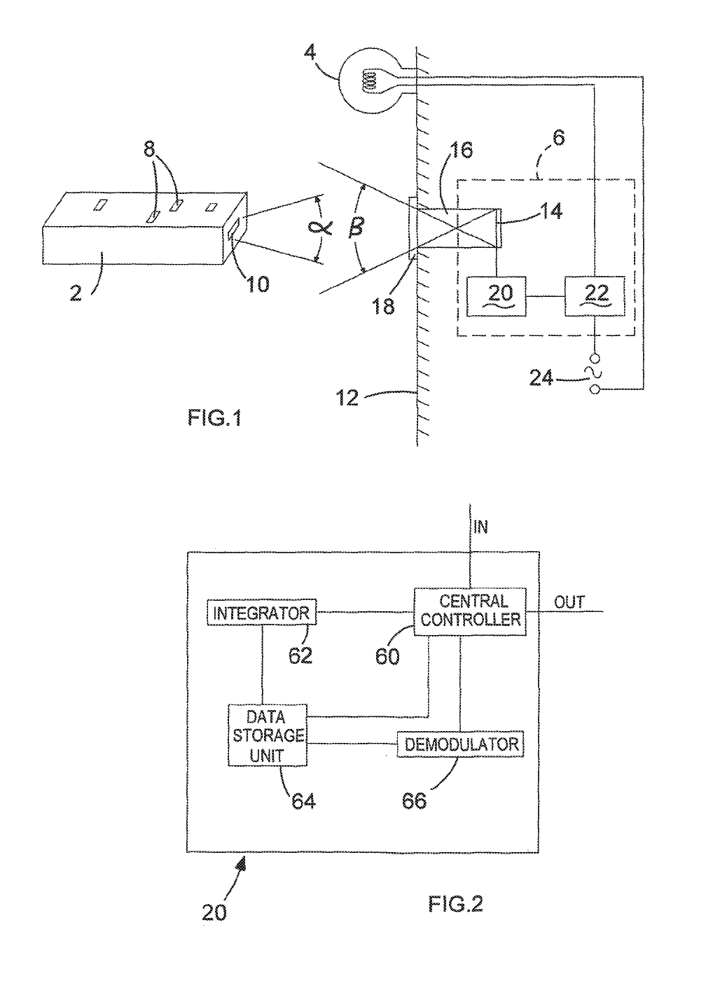

Turning now to the Figures, FIG. 1 depicts a remote control 2, an electric light 4, and an electronic control 6, and FIG. 2 depicts a diagram of the analyzer 20.

The remote control 2 can be arranged to control a target device, such as a television, a CD player, or a DVD player, for example.

A plurality of buttons 8 can be provided on the remote control 2 for controlling different functions of the target device.

An infra red (IR) transmitter 10 can be arranged on the remote control 2 to transmit IR radiation into a solid angle α, such as at a wavelength of approximately 950 nm.

The IR radiation can be modulated using on-off keying at a rate in the range of around 30 kHz to about 80 kHz.

In operation, when one of the plurality of buttons 8 is pressed on the remote control 2, a string of pulses can be emitted from the infra red (IR) transmitter 10 having a pulse width in the micro-second range and an overall length in the milli-second range. The length of a string of pulses can be around 100 ms whenever one of the plurality of buttons 8 is pressed. For buttons, such as the volume button on a television remote control, a continuous string of pulses however, can be sent for as long as the button is held.

The electronic control 6 can be situated in a wall 12. The electronic control 6 can include a receiver 14, which can be an IR detector, and can be sensitive to radiation with a wavelength in the range 850 nm to 1050 nm. The receiver 14 can be situated in a recess 16 in the wall 12. The recess 16 can define a solid angle β, such that radiation must be received from within the solid angle β if it is to be received by the receiver 14. Thus, the recess 16 can control the directionality of the receiver 14, thereby controlling the accuracy with which the remote control 2 must be pointed.

A shroud 18 can be provided across the recess 16. The shroud 18 can be made of metal foil and used to absorb and/or reflect a portion of any IR radiation received thereat. As such, the shroud 18 can reduce the sensitivity of the receiver 14. The receiver 14 can have a predetermined sensitivity, such that the receiver 14 can detect radiation that is above a predetermined power. The shroud 18 can reduce the power of radiation received at the receiver 14 to reduce the sensitivity of the receiver.

The electronic control 6 can include an analyzer 20 connected to the receiver 14. The analyzer 20 can be connected to a switch 22. The switch 22 can be arranged to interrupt a main line power supply to the electric light 4. The analyzer 20 can be positioned outside of the main line power supply to the electric light 4.

The analyzer 20 comprises a central controller 60, which can be arranged to receive electrical signals from the receiver 14. The received signals can be integrated by the integrator 62, such as by using a predetermined integration period stored in a data storage unit 64.

The central controller 60 can analyze results from the integrator 62 and look for any increase in signal strength above the background, which can be indicative of a signal received from a remote control 2. For example, the central controller 60 can determine whether the integrated signal strength is above a predetermined threshold stored in the data storage unit 64.

The analyzer 20 can become active once the integrated signal rises above a threshold, but the central controller 60 can send an instruction to the switch 22 whenever the integrated signal falls back below the predetermined threshold. Thus, if a user were to hold one of the plurality of buttons 8 on the remote-control 2 for a long period, such as a second or more, the analyzer 20 can send an instruction to the switch 22 only when the held button 8 is released and the signal strength decreases.

In one or more embodiments, the analyzer 20 can send an instruction to the switch 22 when the signal increases above a predetermined threshold.

The integration period stored in the data storage unit 64 can be set such that the analyzer 20 is insensitive to modulations that occur over a short time period. The integration period used in the analyzer 20 can be less than 100 ms, and greater than around 50 μs. In one or more embodiments the integration period can be around 1 ms. As such, modulations that occur at the micro-second level will not be resolved by the analyzer 20. Therefore, the analyzer 20 can control the switch 22 independently of the characteristics of the modulated signal.

The analyzer 20 can include demodulator 66 for detecting modulations in the signal. To achieve this, the demodulator 66 can employ a further integration of the signal with a period in the order of 1 μs, for instance. The central controller 60 can send a signal to the switch 22 whenever a string of micro-second pulses is detected. In this way, the electronic control 6 can be insensitive to unmodulated signals, such as natural sunlight, which can cause unintended activation of the switch 22.

The switch 22 can be arranged to open or close on the basis of instructions received from the analyzer 20. The switch 22 can be provided in a circuit with the electric light 4 and a power source 24. The operation of the electric light 4 can be controlled by the switch 22, dependent on instructions from the analyzer 20.

For example, the switch 22 can close when the analyzer 20 receives modulated IR radiation from the remote control 2 and the signal strength drops below a predetermined value. The switch 22 can open when the signal again drops below a predetermined value, such as when there are two separate button depressions on the remote control 2. To result in two separate activations of the switch 22, the button depressions must be separated by a predetermined time period, which can be at least equal to the integration period of the analyzer 20.

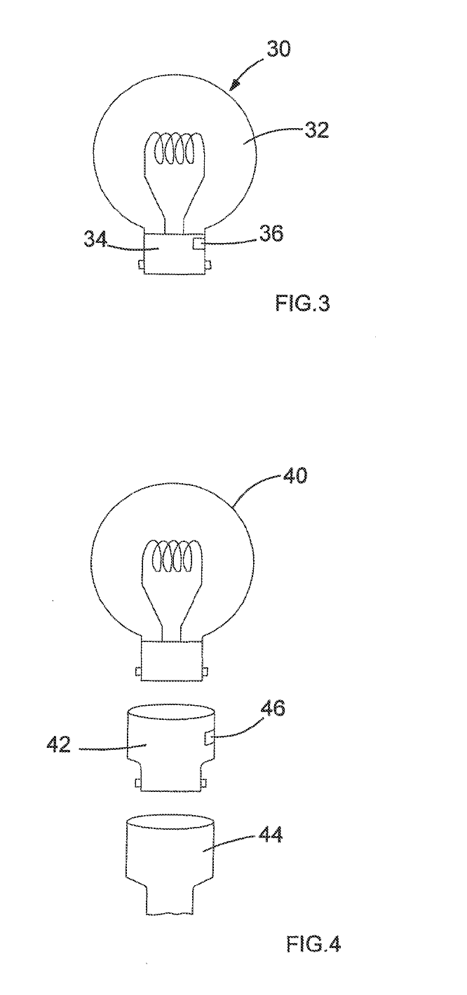

FIG. 3 depicts a light bulb 30 having an IR receiver 36. The light bulb 30 can include a bulb portion 32 and a connector portion 34.

The IR receiver 36 can be a single component in the electronic control, which can be integrated within the connector portion 34. The IR receiver 36 can be visible in a window defined by the housing of the connector portion 34.

The light bulb 30 can be connected to a conventional light fitting and operated as a normal bulb. As an additional feature, the light bulb 30 can be switched on or off using the electronic control including the IR receiver 36 that can be integrated within the connector portion 34. For example, a user can point a remote-control at the IR receiver 36 and press a button on the remote control. The electronic control including the IR receiver 36 can detect the received IR radiation from the remote control, and the analyzer can control the light bulb 30 accordingly by operation of the switch.

FIG. 4 depicts an exploded view of a light bulb 40, an adaptor 42, and a light fitting 44.

The adapter 42 can be arranged to connect to the light fitting 44, and the light bulb 40 can be arranged to connect with the adapter 42. The adapter 42 can include an IR receiver 46 as part of the electronic control, which can be integrated within the adapter 42. The adapter 42 can be connected to any standard light fitting and can be used to control the operation of the light bulb 40 when modulation is detected in IR radiation received by the IR receiver 46.

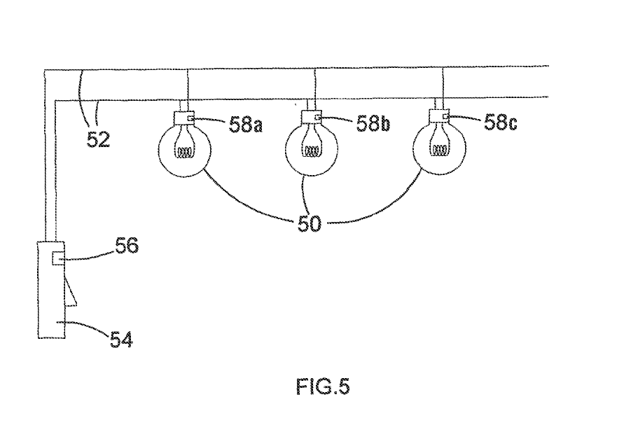

FIG. 5 depicts a string of light bulbs 50 connected in parallel with power lines 52. The string of light bulbs 50 can be controlled by a switch 54, which can include an IR receiver 56. The IR receiver 56 can be part of an electronic control embedded within the switch 54.

Each light bulb of the string of light bulbs 50 can include an IR receiver, including IR receiver 58a, IR receiver 58b, and IR receiver 58c. Each IR receiver 58a-58c can be part of an electronic control integrated within each of the light bulbs in the string of light bulbs 50.

In operation, the string of light bulbs 50 can be controlled conventionally using the switch 54 to turn all of the light bulbs in the string of light bulbs 50 on or off simultaneously. The string of light bulbs 50 can be controlled remotely using an IR remote-control pointed at the IR receiver 56 to turn all of the light bulbs in the string of light bulbs 50 on or off simultaneously. Also, each light bulb in the string of light bulbs 50 can be turned on or off individually by using a remote-control pointed at the relevant IR receiver 58a-58c.

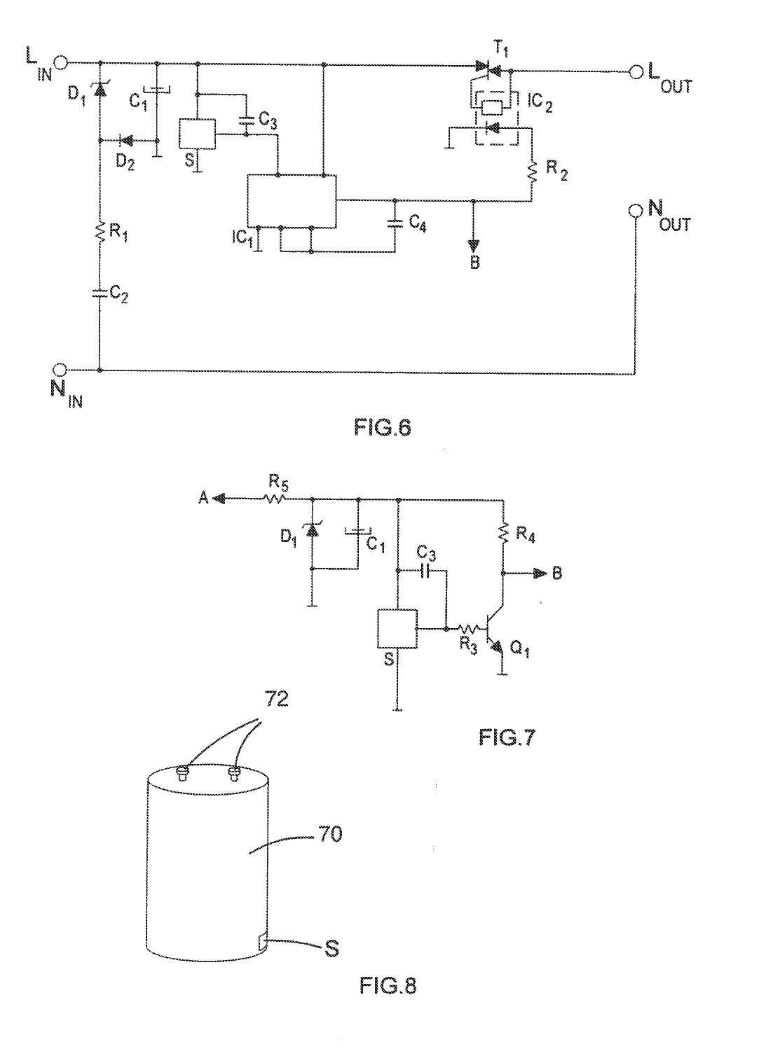

FIG. 6 depicts a circuit diagram of a control, such as one that can be embodied in the analyzer. The power supply can be provided via capacitor C2, resistor R1, capacitor C1, and diodes D1 and D2. The components of the control depicted in FIG. 6 can be arranged to stabilize the power supply and convert AC power to DC power.

An IR sensor S can be arranged to receive IR radiation. A capacitor C3 can be arranged to charge when the capacitor C3 receives a signal from the IR sensor S, and while the IR sensor S is receiving IR radiation. The charge time of the capacitor C3 can be designed such that the signal can be integrated with an integration period that exceeds the period of pulses in the IR radiation.

A bi-stable chip IC1 can receive an input from the IR sensor S and the capacitor C3. The bi-stable chip IC1 can change its output from low to high when radiation is detected by the IR sensor S and when the capacitor C3 has charged fully.

The bi-stable chip IC1 can provide a low power output B. The low power output B can be used as an input to an existing control system, such as an electronic control system in an electrical component. For example, the low power output B can be received as an input that enables the start-up sequence for a fluorescent tube.

The circuit of the controller can include an optional power switch, including an integrated circuit IC2 and a TRIAC T1, enabling for the direct control of power to a load when the integrated circuit IC2 and the TRIAC T1 receive the low power output B via a resistor R2. The circuit can also include a capacitor C4.

FIG. 7 depicts another circuit diagram of a control, such as one that can be integrated in an electrical component that uses electronic ballasts, such as an electronic starter for a fluorescent tube or a low power fluorescent light.

The power input to the circuit of FIG. 7 can be DC and low power; thus the circuit does not include components for rectification but does include components for stabilizing and filtering a power input.

The circuit of FIG. 7 can include an IR sensor S and a capacitor C3 that can be arranged to integrate a signal from the IR sensor S. The IR sensor S and the capacitor C3 can provide an input to a transistor Q1 via a resistor R3. When the capacitor C3 has charged and the input signal to the transistor Q1 exceeds a certain threshold, the transistor Q1 can switch on in order to provide the low power output B.

The circuit can also include a resistor R4, a resistor R5, the capacitor C1, and the diode D1.

FIG. 8 depicts an electronic starter 70, which can be integrated with the circuit of FIG. 7. The electronic starter 70 can be for a fluorescent tube.

The electronic starter 70 can include electrical contacts 72 for connection with contacts in a light fitting. The IR sensor S, which can be the same as the IR sensor S shown in FIG. 7, is shown in a window for receiving IR radiation. The remaining components of the circuit shown in FIG. 7 can be hidden within a housing of the electronic starter 70.

Referring to FIGS. 6-8, in operation of the electronic starter 70 and the IR sensor S can be arranged to receive IR radiation from a standard remote-control.

The capacitor C3 can be arranged to integrate a signal from the IR sensor S over a period that is longer than the period of a modulated pulse in the received IR radiation. When a high input is received by the transistor Q1, the transistor Q1 can switch on in order to provide the low power output B, which can initiate the start-up sequence of a low power light.

In a standard start up sequence, the electronic starter 70 can cause the filament ends of a fluorescent tube to heat up before electronic starter 70 strikes in order to initiate operation of the fluorescent tube.

The power draw of the circuits shown in FIGS. 6 and 7 can be around 0.5 mW to 20 mW. The circuits shown in FIGS. 6 and 7 can include an additional capacitor (not shown) that can be arranged to charge during normal operation of an electrical device. A slow discharge of the additional capacitor could supply the circuits with power so that there is no need for a continual external supply of power.

In one or more embodiments, the operation of the components of the circuits shown in FIGS. 6 and 7 can be incorporated into a single integrated circuit. Though the circuits shown in FIGS. 6 and 7 can be made small enough to be integrated into a component, such as the electronic starter 70, the use of a single integrated circuit can enhance miniaturization.

While these embodiments have been described with emphasis on the embodiments, it should be understood that within the scope of the appended claims, the embodiments might be practiced other than as specifically described herein.

What is claimed is:

1. An electrical device having integrated control means, the integrated control means comprising:
a. a receiver for receiving modulated electromagnetic radiation;
b. means for integrating the received modulated electromagnetic radiation over an integration period; and
c. means for controlling an aspect of the electrical device when the modulated electromagnetic radiation is detected, wherein the integration period is greater than a period of a pulse in the modulated electromagnetic radiation such that the aspect of the electrical device is controlled independently of modulation in the received modulated electromagnetic radiation.

2. The electrical device of claim 1, wherein the electrical device is an electronic starter for a fluorescent light.

3. The electrical device of claim 1, wherein the integrated control means are arranged to control the aspect of the electrical device between two states.

4. The electrical device of claim 1, wherein a sensitivity of the receiver to electromagnetic radiation is controlled.

5. The electrical device of claim 4, wherein the sensitivity of the receiver to electromagnetic radiation is controlled in at least one direction.

6. The electrical device of claim 1, further comprising a shroud for the receiver.

7. The electrical device of claim 1, further comprising a structure, wherein the receiver is recessed in the structure.

8. The electrical device of claim 1, wherein the receiver is sensitive to infra-red radiation.

9. The electrical device of claim 1, wherein the integration period is lms.

10. The electrical device of claim 1, further comprising means for detecting modulation in the received modulated electromagnetic radiation, wherein the electrical device is controlled when modulation is detected.

11. The electrical device of claim 10, wherein the means for detecting modulation is arranged to detect amplitude modulation.

12. A method of controlling an electrical device comprising:
a. receiving modulated electromagnetic radiation using components integrated with the electrical device;
b. integrating the received modulated electromagnetic radiation over an integration period using components integrated with the electrical device; and
c. controlling an aspect of the electrical device when modulated electromagnetic radiation is detected using components integrated with the electrical device, wherein the integration period is greater than a period of a pulse in the modulated electromagnetic radiation such that the aspect of the electrical device is controlled independently of modulation in the received modulated electromagnetic radiation.

13. A remote control system comprising:
a. an electrical device comprising integrated control means, wherein the integrated control means comprise:
(i) a receiver for receiving modulated electromagnetic radiation;
(ii) means for integrating the received modulated electromagnetic radiation over an integration period; and
(iii) means for controlling an aspect of the electrical device when the modulated electromagnetic radiation is detected, wherein the integration period is greater than a period of a pulse in the modulated electromagnetic radiation such that the aspect of the electrical device is controlled independently of modulation in the received modulated electromagnetic radiation; and
b. a transmitter for transmitting the modulated electromagnetic radiation, wherein radiation from the transmitter is modulated differently in response to different user actions, and wherein the electrical device is controlled in the same way independently of the modulations in the received modulated electromagnetic radiation.
